(19) United States
(12) Patent Application Publication
(10) Pub. No.: US 2006/0186157 A1
(43) Pub. Date: Aug. 24, 2006

(54) Ski rack for pickup trucks

(76) Inventor: Richard J. Dibble, Lackawanna, NY (US)

Correspondence Address: William J. Crossetta, Jr., 905 Convention Towers, 43 Court Street, Buffalo, NY, 14202, US

(21) Appl. No.: 11/061,817

(22) Filed: Feb. 22, 2005

(51) Int. Cl. B60R 9/00; B60R 7/00

(52) U.S. Cl. 224/405; 224/403; 224/917.5

(57) ABSTRACT

A ski rack, for securing skis to the bed of a truck is disclosed having a mounting frame which rests upon the bed of a truck and is divided into three serially aligned connected compartments sharing common walls, with a common wall between a large middle compartment and a front compartment arranged to secure a front portion of the skis with the curved end thereof extending into the front compartment for storage, the middle compartment arranged to store a middle portion of the skis, a common wall between the middle compartment and a rear compartment arranged to secure a rear portion of the skis, and a rear compartment arranged to store additional ski equipment.

The invention relates to a ski rack for pickup trucks. More particularly, the invention relates to a hidden ski rack which secures one or more skis, ski poles and ski boots within the bed of a pickup truck in a weather protected, non-obtrusive container.

### BACKGROUND OF THE INVENTION

Skiing is a very popular sport which involves the transporting of expensive and bulky equipment, usually by personal vehicle. Skiing generally requires snow and the average snow skier finds himself traveling many miles over salt and cinder treated snow and icy roads to an appropriate ski facility to enjoy his sport. Pick-up trucks are popular personal vehicles which have very limited room in their passenger compartment to store equipment generally used by skier(s) and storage of the equipment in the bed of the truck generally exposes the equipment to the weather, salt, cinders and dirt of the highway during transportation. Equipment is expensive and stops along the way become worrisome occasions as to whether someone may steal the equipment from the bed of the truck. The availability of secure, effective and convenient devices for transporting skis and skiing accessories in the bed of pick-up trucks has not kept up with the resulting demand and most such devices introduced into the marketplace have been awkward adaptations of commonly available ski equipment carrying systems.

U.S. Pat. No. 4,469,257 to Parker discloses a ski rack device for a pickup truck which attaches to the sides of one of the wheel-wells and supports a pair of skis above the well. Parker is not intended for supporting other ski equipment or protecting ski accessories. Parker exposes the skis carried thereby to the elements and the full view of all. Such system provides little security from theft and indeed may attract such.

U.S. Pat. No. 5,390,837 to Ruffolo, Jr. discloses a snow-board rack which uses a base unit having a suction cup for securing the base unit against the exterior surface of the rear window of the pick-up and the snowboard is supported vertically therefrom. Ruffolo places the snow-board in a position where it is highly vulnerable to wind, weather, salt and dirt kicked up during transportation. It exposes the snow-board to considerably drag wherein the resulting forces can rip the rack free of the vehicle, and is highly vulnerable to theft.

U.S. Pat. No. 6,019,265 to Deloza discloses a snow-board rack which uses a tensed spring header shaft to engage opposite inside walls of a pick-up bed and contains an elongate slidable carrier to which a snow-board is mounted on edge. The carrier can be slid to various positions between the sides of the bed. This rack exposes the mounted snow-board to the weather, comprises no means for supporting ski accessories and is highly vulnerable to theft.

U.S. Pat. No. 5,568,890 to Magee et al discloses a vehicle storage cabinet having a base and top which can be sized to about the dimensions of the bed of a pick-up truck and having a height less than one half the height of the bed. The top is divided into left and right doors which are hinged along a center support of cabinet to enable access to the cabinet. No disclosure is indicated of a utility or spacing suitable for storing skis or ski accessories therein nor of a means to retain skis or accessories in a securely mounted position.

While these units may be suitable for the particular purpose employed, or for general use, they would not be as suitable for the purposes of the present invention as disclosed hereafter.

It is an object of the invention to provide a ski rack which allows the secure mounting and convenient carrying of skis and ski accessories in a weather and theft resistant, non-obvious compartment close to the floor in the bed of a truck, particularly pick-up trucks, effectively shielded from the wind.

### SUMMARY OF THE INVENTION

The ski rack of the invention generally comprises a unique mounting frame and hinged door arrangement defining a portable compartmented rack for securely mounting skis and related skiing equipment to the generally flat surface of a bed of a truck, van or the like.

The mounting frame rests on the bed of the truck and comprises spaced, elongate left and right well side members arranged longitudinally on the bed adjacent to the left and right wheel-wells; spaced opposing elongate front and rear connecting members extending between opposing interior side walls of the bed, the front connecting member spaced forward of the wheel-wells between the wheel-wells and the interior of the front bed wall, and the rear connecting member spaced rearward of the wheel-wells between the wheel-wells and the interior rear tailgate wall. The front and rear connecting members cross and connect to the left and right well side members defining a generally rectilinear middle box on the bed of the truck.

A front side member extends between the ends of the elongate well side members, adjacent the interior of the front bed wall, forming a generally rectilinear front box on the bed of the truck. A rear side member extends between the ends of the elongate well side members, adjacent the interior rear tailgate wall, forming a generally rectilinear rear box on the bed of the truck. The elongate well side members define the left and right aligned sides of each of the three boxes; the front side and rear side members define the outside walls of the front and rear boxes respectively; and the front and rear connecting members define common sides between the three generally rectilinear boxes.

A door panel, is arranged to cover the area defined within the three boxes and is hinged to the front side member to cover and provide access to the three boxes, with the underside being the bed of the truck.

The front and rear connecting members comprise the means for retaining skis and ski poles in organized secure arrangement within the rack. In one embodiment, the front and rear connecting members comprise aligned slots arranged in their walls which define the middle box. The slots are dimensioned to accept skis turned on edge, with their bindings positioned in the middle box and curved front positioned in the front or rear box. Further aligned slots can be arranged to accept ski poles and the like. The slots are dimensioned in depth so that the opposite edge of skis and/or poles installed therein are at or below the level of the door when it is closed. Generally, the length between the front and rear ends of a wheel well is longer than the length of bindings and the front and rear connecting members can be arranged thereat.

Various other ski and pole mounting means can be used in conjunction with the front and rear connecting members. In other embodiments, the connecting members may comprise common ski mounting means, such as post and elasticized band ski mounting means, co-acting jaw attachment means, “U” shaped mounting means and the like. Generally any ski and or pole mounting means of the prior art can be adapted to mount skis and/or poles to the cross members.

Generally it is desired to arrange skis so that the curved top ends of the skis rest in the front box and the generally flat rear ends extend as little as possible, if at all, into the rear box. Such arrangement provides significant room in the rear rectilinear box for storage of ski boots, goggles, hats and the like.

The boxes formed by the frame of the rack of the invention can be of any convenient length, width or depth within the confines of the bed length from front to back and bed width from wheel-well to wheel-well. It is generally preferred that the depth of the boxes formed be about the same, but such is not required. In a preferred embodiment, the width of the well side members are generally consistent to provide a depth of the boxes from about 5 inches to about 10 inches, a depth which allows convenient day-to-day alternate use of the bed without removal of the rack. In another embodiment the width of the well side members increases at about the rear box providing an increased depth.

The frame and door panel can be formed from any convenient material, including plastic, metal and wood. The elongate well side members and/or connecting members and/or front and rear side members may be connected to the bed or left in interconnecting free standing arrangement.

The door panel generally comprises a support base for loads that may be carried in the bed of the truck when the ski rack of the invention is in place. Though it is not essential, it is generally desired that such door panel be of sufficient strength so that it will not collapse or significantly bow downwardly when bearing a load thereon. The elongate side well members, connecting members and front and rear side members generally provide sufficient supporting structure to retain the door panel from collapse or bowing. In embodiments wherein the connecting members comprise ski and/or pole mounting members which create a reduced depth along the center of the connecting member, it is generally desirable to provide one or more spaced supporting frame extensions or the like to assure the structural support of the door panel. Thus for example one or more boxes may comprise a longitudinal member(s) which divides a box and provides additional support to the door panel. Similarly, ski attachment devices or the like may be of measured depth in structure to provide support to the door panel.

In one preferred embodiment the well side members, connecting members, front and rear side members, and hinged door panel are formed from wood, the well side members and connecting members being connected by blind-halved lap construction. The door panel is hinged to the front side member and pivots open from the rear side member. Such construction provides significant benefit in that the weight and bulk of the structure discourages theft, and provides stabilizing weight to the pick-up for driving on snowy roads. Locking the unhinged end of the door to the rear side member assures structural integrity of the structure when assembled in the truck bed and allows convenient disassembly for storage. Manufacturing the frame members from 2″×6″ or greater lumber and the door from ¼ inch or better plywood or the like provides a significantly strong base upon which heavy loads can be stacked, thus reducing the limitations that might otherwise be placed upon the use of the truck when the rack is installed.

The elongate members can be whole formed lengths or assembled from two or more shorter lengths. Thus, a metal or plastic ski rack of the invention may comprise a plurality of interconnecting short lengths which form the walls of the generally rectilinear boxes of the invention and extensions thereof for engaging the side walls of the bed of the truck.

To the accomplishment of the above and related objects the invention may be embodied in the form illustrated in the accompanying drawings. Attention is called to the fact, however, that the drawings are illustrative only. Variations are contemplated-as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a diagrammatic perspective view of a pickup truck bed with a ski rack of the invention installed therein.

FIG. 2 is a exploded perspective view, of another embodiment of the ski rack of the invention.

FIG. 3 is a perspective view of a further embodiment of the invention.

FIGS. 4A-4B are partial side elevational views of a connecting member of FIG. 3 with a post and band ski mount.

FIGS. 4C-4D are partial side elevational views of a connecting member of FIG. 3 with an open “U” shaped ski mount.

FIGS. 4E-4F are partial side elevational views of a connecting member of FIG. 3 with a closed “U” shaped ski mount.

### DETAILED DESCRIPTION OF THE DRAWINGS

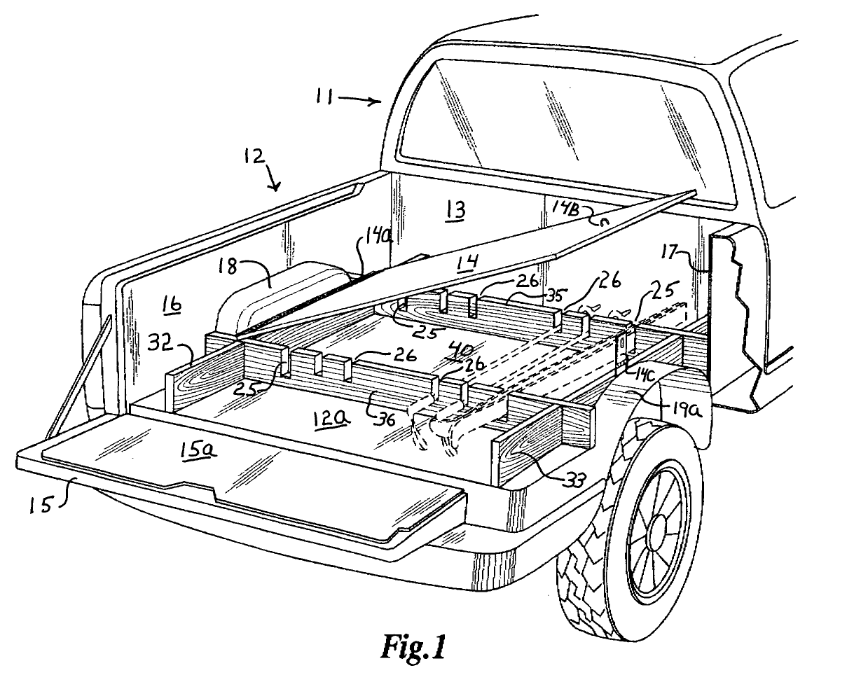

FIG. 1 illustrates a rear sectional view of a pick-up truck with an embodiment of a ski rack of the invention mounted in the load bed thereof. The truck has a cab 11 with a load compartment 12 rearward of the cab. The load compartment has an interior front wall 13 and a tail gate 15 located at the rear thereof comprising an interior rear wall 15a. A pair of generally parallel interior side walls 16 and 17 extend upward from bed 12a of the compartment, between interior front wall 13 and interior rear wall 15a. Left wheel well 18 extends upward from bed 12a and outward from interior side wall 16. A right wheel well (not shown) extends upward from bed 12a and outwardly from interior side wall 17 directly opposite left wheel well 18, arranged to cover wheel stone guard 19a.

Load compartment 12 is illustrated as comprising an embodiment of the a ski rack illustrated as laying upon bed 12a, with a plurality of aligned ski slots 25 arranged to support skis on end (in phantom) and aligned pole slots 26 arranged to support ski poles (in phantom). Skis are customarily manufactured to be stored with their bottom surfaces in mating facing engagement. Ski slots 25 are illustrated as having a depth greater than or about equal to the width of skis to be mounted therein and a width greater than the thickness of typical mating skis. Though not shown, skis have boot binders mounted on their top surface, at about the middle thereof.

The ski rack comprises a mounting frame and hinged door arrangement, the mounting frame resting on bed 12a of the load compartment and comprising elongate left well side member 32 and right well side member 33 arranged longitudinally on the bed adjacent to the left side wheel-well 18 and the right side wheel well (not shown) respectively extending upward from the bed. Elongate front connecting member 35 and rear connecting member 36, extend between interior side walls 16 and 17 of the load compartment. Front connecting member 35 is spaced forward of the wheel-wells, between the wheel-wells and interior front side wall 13 of the compartment. Rear connecting member 36 is spaced rearward of the wheel-wells, between the wheel-wells and interior rear tailgate wall 15a. Front and rear connecting members 35 and 36 are illustrated as crossing and connecting to left and right well side members 32 and 33 by blind-halved lap construction defining a generally rectilinear middle box 40, having a front to rear dimension greater than the length of ski boot binders typically arranged on skis. The depth of the well side members and connecting members is greater than the maximum width of skis mounted in the ski rack.

Door 14 is hinged 14a to the left well side member and comprises a staple 14b and hasp 14c arrangement for locking. Door 14 is illustrated as covering middle box 40, and when closed prevents removal of the skis poles and any other items arranged therein. In the embodiment of FIG. 1, the bed 12a of the compartment truck comprises the base of the middle box, but an attached base or the like is contemplated as within the disclosure of the invention.

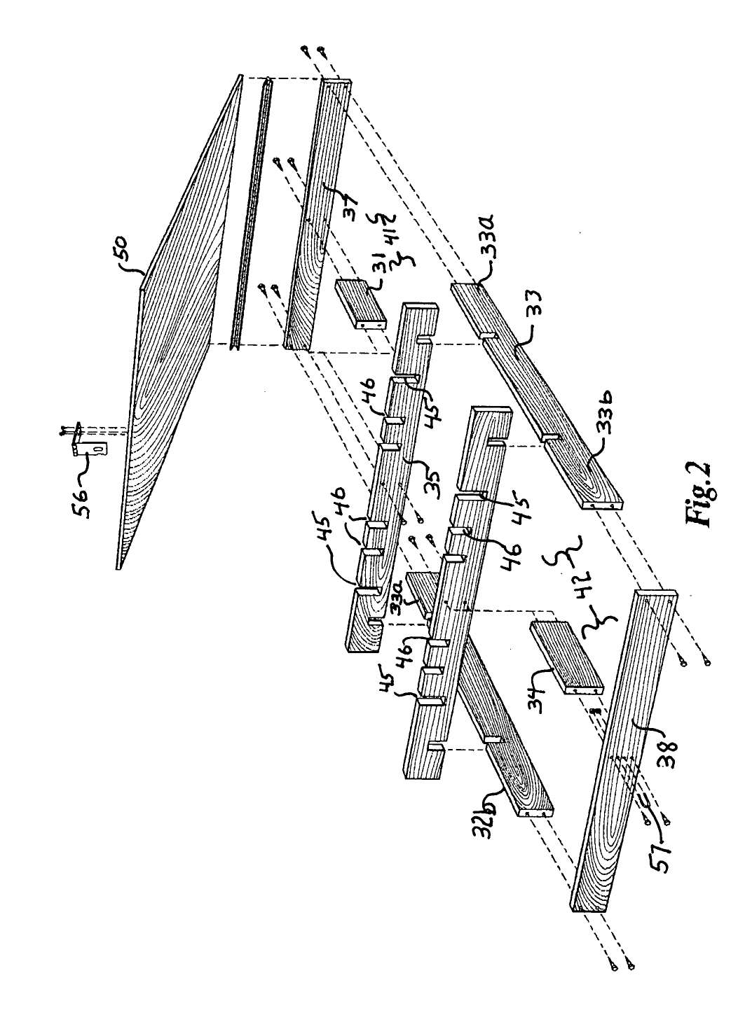

FIG. 2 illustrates an embodiment of the ski rack of FIG. 1 comprising a front side member 37 extending between ends 32a and 33a of elongate well side members 32 and 33 arranged adjacent interior front wall 13 (not shown in FIG. 2), forming a generally rectilinear front box 41; and rear side member 38 extending between ends 32b and 33b of elongate well side members 32 and 33 adjacent interior rear side wall 15a (not shown in FIG. 2), forming generally rectilinear rear box 42. Elongate well side members 32 and 33 define the left and right aligned sides of each of boxes 40, 41 and 42; front side and rear side members 37 and 38 define the outside walls of the front and rear boxes 41 and 42 respectively; front and rear connecting members 35 and 36 define common sides between the three generally rectilinear boxes and comprise ski and ski pole mounting slots. Dividing members 31 and 34 are illustrated as dividing front box 41 and rear box 42 into separate compartments.

Ski mounting slots 45 are arranged in longitudinal alignment in front and rear connecting members 35 and 36 respectively. Skis, arranged with bases facing, are inserted on edge into slots 45 with boot binders arranged in center box 40, curved top ends in front box 41 and flat rear ends in rear box 42 or vice-versa. Slots 45 are dimensioned in depth at least to the width of skis intended to be mounted therein and in width to at least the combined thickness of a pair of skis.

Pole mounting slots 46 are also arranged in longitudinal alignment in front and rear connecting members 35 and 36 respectively. Ski poles, comprising snow piercing ends and opposite gripping ends, are inserted into the slots which are dimensioned in width to at least the diameter of the pole or the handle of the pole. Generally the depth of slots is dimensioned to a depth sufficient to allow clearance of pole baskets without hindering closure of the door arrangement.

Door panel 50 is illustrated as comprising a generally flat panel dimensioned to cover the three boxes formed by the well side members, connecting members and front and rear side members, and be supported thereby. Door panel 50 comprises piano hinge 55, connecting it to front side member 37, and comprises hasp 56 which engages staple 57 on rear side member 38. Depending upon the number of skis and poles being stored, this arrangement can also provide room in the middle box for secure storage of boots, goggles and the like ski equipment. It should be understood that the invention contemplates a single panel covering any one or combination of the boxes formed by the frame of the ski rack and a plurality of two or more separately and/or commonly mounted panels covering any combination of boxes.

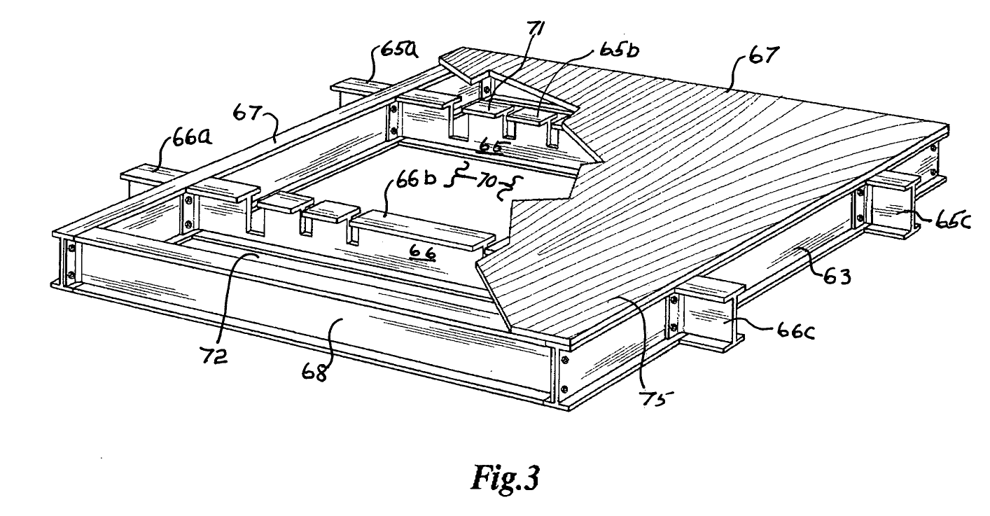

FIG. 3 illustrates a further embodiment of the invention wherein the mounting frame is assembled from a plurality of different length metallic members.

Therein the mounting frame is illustrated as comprising elongate left well side member 62 and right well side member 63 interconnected with front connecting member 65, comprised of sub-members 65a-c, and rear connecting member 66 comprised of sub-members 66a-c. Front and rear connecting members are illustrated as crossing and connecting to left and right well side members by simple nut and bolt arrangement, defining generally rectilinear middle box 70. Front side and rear side members 67 and 68 define the outside walls of front and rear boxes 71 and 72 respectively, with sub-members 65b and 66b of front and rear connecting members 65 and 66 defining common sides between the three generally rectilinear boxes and comprising ski and ski pole mounting slots. Door panel 75 is illustrated as covering the three formed boxes.

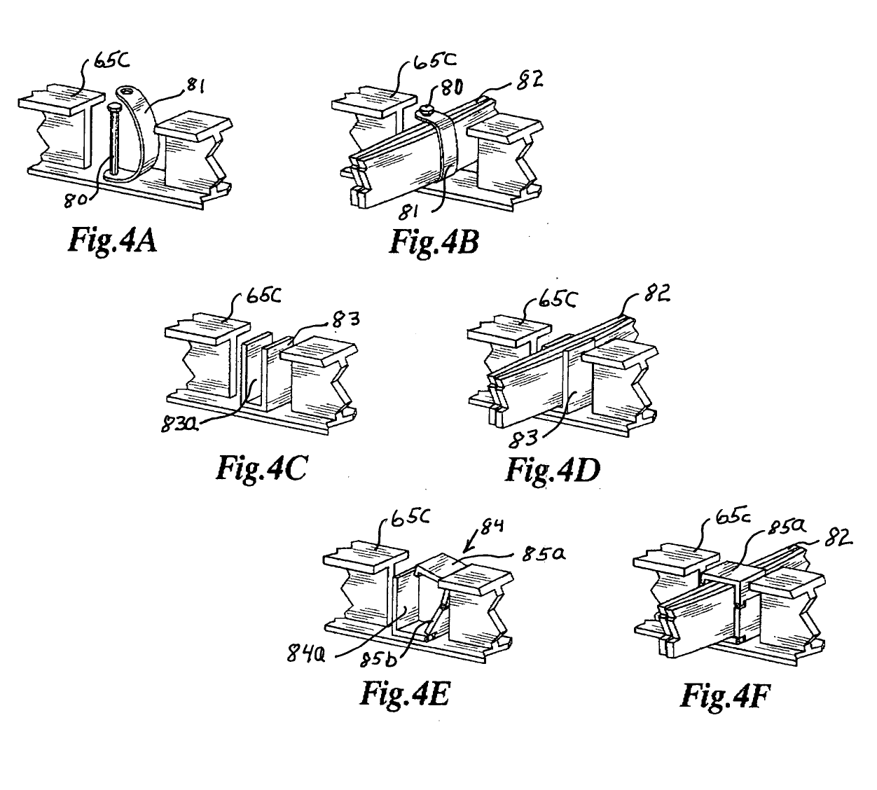

FIGS. 4A-4B illustrate an example of a post and band means arranged on submember 65c for mounting skis 82 wherein the skis are held in place against post 80 by elasticized band 81.

FIGS. 4C-4D illustrate an example of an upright “U” means arranged on submember 65c for mounting skis 82 wherein the skis rest on edge in slot 83a of “U” member 83.

FIGS. 4E-4F illustrate an example of an closed “U” means arranged on submember 65c for mounting skis 82 wherein the skis rest on edge in slot 84a of “U” member 84, and legs 85a-b are pivotally connected to enable locking the skis in place.

It should be understood that it is within the contemplation of the invention that post 80, the ends of “U” member 83 and the top surface of leg 85a may be dimensioned to the height of the submember to provide added support for be door panel means 75.

I claim:

1. A ski rack, for securing a ski to a generally flat surface comprising;
a mounting frame having spaced, generally parallel, elongate left and right well side members with opposing first and second ends, said well side members being connected at points spaced from said ends, by spaced, generally parallel, elongate front and rear connecting members, said connecting members extending between said left and right well side members and forming a generally rectilinear middle compartment therewith;
wherein said front and rear connecting members forming said generally rectilinear middle box comprises means for securing a middle portion of a ski within said middle compartment.

2. The ski rack of claim 1 wherein a front side member extends between opposing first ends of said elongate well side members forming a generally rectilinear front compartment.

3. The ski rack of claim 1 wherein a rear side member extends between opposing second ends of said elongate well side members forming a generally rectilinear rear compartment.

4. The ski rack of claim 1 wherein said connecting members are spaced from each other at least the distance from front to rear of a wheel well extending into the bed of a truck.

5. The ski rack of claim 1 wherein said well side members are spaced from each other less than the distance between wheel wells extending into the bed of a truck.

6. The ski rack of claim 1 wherein a connecting member is sized to engage at least one of wheel well wall and side bed wall of a truck.

7. The ski rack of claim 1 wherein at least one of said well side members is formed from wood.

8. The ski rack of claim 7 wherein at least one of said connecting members is formed from wood.

9. The ski rack of claim 8 wherein a wooden connecting member comprises a slot for securing a ski.

10. The ski rack of claim 1 wherein said means for securing comprises at least one of slot, post, co-acting jaw and “U” shaped mounting means.

11. The ski rack of claim 1 wherein at least one of said well side members is formed from metal.

12. The ski rack of claim 11 wherein at least one of said connecting members is formed from metal.

13. The ski rack of claim 1 wherein at least one of said elongate members is assembled from two or more shorter lengths.

14. The ski rack of claim 13 wherein said elongate members are formed from interconnecting shorter metal lengths.

15. The ski rack of claim 1 comprising means for securing a middle portion of a ski pole within said middle compartment.

16. The ski rack of claim 1 comprising a panel, arranged to cover said middle compartment.

17. The ski rack of claim 2 comprising a panel, arranged to cover a front and middle compartment.

18. The ski rack of claim 3 comprising a panel, arranged to cover a rear and middle compartment.

19. A ski transporting and storage method, for use in the bed of a pickup truck, comprising:
providing a mounting frame on the floor of the bed of a pickup truck, said mounting frame having spaced, generally parallel, opposing elongate left and right well side frame members longitudinally arranged between wheel wells extending upwardly from said bed of said truck, and connected at points spaced from opposite ends of said well side frame members to spaced, generally parallel, elongate front and rear connecting members, said connecting members extending between said left and right well side members and forming a generally rectilinear middle compartment therewith;
providing means for securing a middle portion of a ski within said middle compartment, along that portion of said front and rear connecting members which forms said generally rectilinear middle box.

20. The ski transporting and storage method of claim 19 wherein a front side member extends between opposing first ends of said elongate well side members arranged to form a generally rectilinear first compartment with said connecting members; and
a rear side member extends between opposing second ends of said elongate well side members arranged to form a generally rectilinear second compartments with said connecting member.

21. The ski transporting and storage method of claim 20 comprising a panel, arranged to cover said first, second and middle compartments.

22. The ski transporting and storage method of claim 19 wherein said means for securing a said ski comprises at least one of slot, post, co-acting jaw and “U” shaped mounting means.

23. The ski transporting and storage method of claim 19 wherein at least one of said elongate members is assembled from two or more shorter lengths.

24. A compartmented ski rack, for securing skis to the bed of a truck, having a mounting frame which defines three serially aligned connected compartments with adjoining compartments sharing common framing, the common framing between a middle compartment and a front compartment comprising means to secure a front portion of skis with the curved end thereof extending into the front compartment for storage, the middle compartment arranged to store a middle portion of said skis, common framing between the middle compartment and a rear compartment comprising means to secure a rear portion of said skis, and a rear compartment arranged for general storage.

25. The compartmented ski rack of claim 24 comprising a panel, arranged to cover said front, middle and rear compartments.
